(19) United States
(12) Patent Application Publication
(10) Pub. No.: US 2021/0387485 A1
(43) Pub. Date: Dec. 16, 2021

(54) PNEUMATIC TIRE WITHOUT INNER TUBE AND UNSUPPORTED BY SIDEWALL

(71) Applicants: XIANGPO WEI, BEIJING (CN); ZHAOYING MENG, TIANJIN (CN)

(72) Inventors: XIANGPO WEI, BEIJING (CN); ZHAOYING MENG, TIANJIN (CN)

(21) Appl. No.: 17/459,802

(22) Filed: Aug. 27, 2021

Related U.S. Application Data
(63) Continuation-in-part of application No. PCT/CN2020/076583, filed on Feb. 25, 2020.

(30) Foreign Application Priority Data
Feb. 28, 2019 (CN) 201910149342.2

(51) Int. Cl. B60C 17/10; B60C 5/12

(52) U.S. Cl. CPC B60C 17/103; B60C 2017/0081; B60C 5/12

(57) ABSTRACT

Disclosed is a pneumatic tire without inner tube and unsupported by sidewall, wherein a wear-resistant layer or a wear-resistant lubrication layer is disposed at an inner surface rubber layer of a tire outer side, or disposed at an inner surface rubber layer of the tire outer side and a tire inner side. The wear-resistant layer is located at at least one of the following three portions: a tire bead, a tire sidewall, and a tire shoulder. After the tire, which is zero-pressure tire, goes flat, two surfaces of the inner surface rubber layer come into contact with each other, wherein the wear-resistant layer provided at the contact position can improve wear resistance and increase tire mileage and speed limitations.

### FIELD OF THE DISCLOSURE

The present disclosure relates to a pneumatic tire without inner tube and unsupported by sidewall, which belongs to the field of tire technologies.

### BACKGROUND OF THE DISCLOSURE

Once a tire without inner tube and unsupported by sidewall blows, the tire goes flat, inner surfaces of a tire inner surface rubber layer come into contact with each other, a vehicle body tilts, and a camber angle of a wheel changes. The camber angle of the wheel is an angle between a plane in which the wheel is located and a vertical plane after the wheel is mounted. When tires have a “Λ” shape, it is called negative camber. When tires have a “V” shape, it is called positive camber. Referring to FIG. 8, the wheel in FIG. 8 is a right-side wheel of a vehicle.

Once a tire unsupported by a sidewall blows, the tire has zero pressure and goes flat. Rolling resistance is greatly increased for the flat-tire wheel. Forces at the left and right sides are severely unbalanced. It becomes increasingly difficult to handle the vehicle.

During a high-speed movement of the vehicle, once a tire blows, the tire goes flat. Especially, it is extremely dangerous when the tire of a turning wheel blows. To ensure flexible and stable steering of the vehicle, a camber angle of the turning wheel is usually small, and is nearly zero. Once the tire of the turning wheel blows, a tire unsupported by a sidewall goes flat, and the vehicle body tilts. The camber angle of the flat-tire wheel is positive, and a side of a rim at a tire outer side comes into contact with the ground first. In this case, if the flat tire is subject to a relatively large lateral force from the tire outer side to a tire inner side, a tire lip at the tire outer side slides into a groove of a top-mounted hub. Once the tire lip slides into the groove of the hub, a relatively large relative movement occurs between a tire tread and the hub, and a rim of the hub at the tire outer side has a risk of directly coming into contact with the ground. Both braking and steering of the vehicle may be out of control, which is likely to cause a traffic accident. Nearly all commercially available hubs are top-mounted hubs. The top-mounted hub is a hub with the rim of the hub at the tire outer side being adjacent to the groove of the hub after the hub is mounted on the vehicle.

To make the vehicle more stable, camber angles of rear wheels are usually set to “A” shaped negative camber. When the vehicle moves at a particular speed in a curve, once a tire blows at an outer side of the curve, the vehicle body tilts. With the additional action of a centrifugal force, the vehicle body tilts more. In a particular case, the camber angle of the flat-tire wheel may become positive camber, a side of a rim of the tire outer side comes into contact with the ground first. If the flat tire is subject to the relatively large lateral force from the tire outer side to the tire inner side, the tire lip on the tire outer side slides into the groove of the top-mounted hub. Once the tire lip slides into the groove of the hub, a relatively large relative movement occurs between the tire and the hub. The rim of the hub at the tire outer side has a risk of directly coming into contact with the ground. Both braking and steering of the vehicle may be out of control, which is likely to cause a traffic accident. Even if the camber angle of the flat tire is zero or relatively small camber, if the flat tire is subject to the relatively large lateral force from the tire outer side to the tire inner side, the tire lip on the tire outer side also slides into the groove of the top-mounted hub.

In the prior art, when a self-support run-flat tire with a thickened and reinforced tire sidewall has zero pressure, a tire sidewall can still support the weight of a vehicle body for a movement at a particular speed for a period of time. However, such a technology has particular deficiencies: 1. After the tire sidewall is thickened and reinforced, the tire becomes more rigid and a vehicle becomes less comfortable, there are relatively high requirements for the chassis and shock absorption, and in addition the tire is subject to impact, making a hub high prone to damage. 2. The mounting is difficult, and a dedicated tire removing device is required. 3. The tire has a heavy weight, low controllability, high fuel consumption, and a high use cost, and is not environmentally friendly. 4. The tire is expensive, and a mounting cost is high. 5. A sidewall has a limited support force and cannot be used for a vehicle such as a coach or a van that has a relatively heavy vehicle body. Therefore, the technology is only used in a few vehicle models. 6. After the tire blows and goes flat instantly, the tire sidewall bounces like a spring, causing the vehicle to jolt, making handling more difficult for a driver.

In the prior art, an annular support belt is mounted in a groove of the hub to seal the groove of the hub, to prevent a tire lip from sliding into the groove of the hub when a tire unsupported by a sidewall has zero pressure and goes flat, to avoid a traffic accident. However, such a technology has particular deficiencies: 1. A mounting process is complex, it is not convenient to assemble and disassemble the tire, and a dedicated assembly and disassembly tool is required. 2. When a wheel is relatively heavy, fuel consumption is affected. 3. A cost is high. 4. After the tire has zero pressure and goes flat, although the tire cannot slide into the groove of the hub, under the action of a lateral force, the tire tends to slide off a tire bead seat. After the tire slides off, the lateral force on the tire decreases, and it is very difficult for a driver to accurately control directions. 5. After the tire has zero pressure and goes flat, a contact position on a tire inner surface is subject to friction. A rubber layer on the tire inner surface is a rubber airtight layer, and mainly needs to have adequate airtight performance, but does not need to have relatively high wear resistance and lubrication. The tire inner surface has a large friction coefficient, and friction occurs at the tire inner surface to generate heat and wear, resulting in increased speed limitations when the tire has zero pressure, and a movement distance is short. 6. After the tire has zero pressure and goes flat, wheels have increased rolling resistance, and as a result the left and right wheels are subject to unbalanced forces, and the controllability is low. 7. After mounting, movement balance of the tire tends to be affected, and during use, a potential safety hazard such as loose mounting tends to occur.

In the prior art, a tire bead of a tire unsupported by a sidewall is bonded to a tire bead seat of a rim, to avoid tire bead unseating after the tire loses pressure. The tire and the rim are integrated, making it more difficult to reuse the rim, and it is extremely complex to repair the tire when the tire is punctured. In addition, after the tire has zero pressure and goes flat, friction occurs at a tire inner surface, and a rubber layer on the tire inner surface is a rubber airtight layer, and mainly needs to have adequate airtight performance, but does not need to have wear resistance and lubrication. The tire inner surface has a large friction coefficient, and friction occurs to generate heat and wear, resulting in increased speed limitations when the tire has zero pressure, and a movement distance is short. After the tire has zero pressure and goes flat, the wheels have increased rolling resistance, and as a result the left and right wheels are subject to unbalanced forces.

The present disclosure provides a pneumatic tire without inner tube and unsupported by sidewall, which may overcome the foregoing disadvantages: During a movement of a vehicle, when a tire pressure decreases to zero because the tire without inner tube and unsupported by sidewall blows or for another reason, in consideration of safety and convenience, the zero-pressure tire is not allowed to unseat (unseating refers to that a tire lip falls off a tire bead seat of the hub) to slide into the hub, and the vehicle continues to move a distance to stop at a place that is suitable for replacing the tire. In the present disclosure, the zero-pressure tire allows the vehicle to move a relatively long distance to stop at a place such as a service area, to better ensure the safety of a driver and a passenger. In addition, a person can be protected from cold or very hot weather when replacing the tire on a road.

### SUMMARY OF THE DISCLOSURE

The present disclosure adopts the following technical solution to resolve the technical problem: A pneumatic tire without inner tube and unsupported by sidewall, where a wear-resistant layer is disposed at a tire inner surface rubber layer of a tire outer side, or disposed at a tire inner surface rubber layer of the tire outer side and a tire inner side, and the wear-resistant layer is located at least one of the following three portions: a tire bead, a tire sidewall, and a tire shoulder.

Alternatively, the wear-resistant layer at the tire inner surface rubber layer is at least one of a wear-resistant fabric layer, a wear-resistant paper layer, a wear-resistant film layer, a wear-resistant leather layer, and a wear-resistant coating layer.

Alternatively, the wear-resistant layer is a wear-resistant rubber layer having wear resistance greater than that of an airtight layer.

Alternatively, a thickness of the wear-resistant layer is less than 2 mm.

Alternatively, bending and deformation resistance of the tire sidewall after the wear-resistant layer is disposed at an inner surface rubber layer of the tire sidewall is one to two times the bending and deformation resistance of the tire sidewall before the wear-resistant layer is disposed.

Alternatively, in a case that an inner surface of the wear-resistant layer has the same roughness, a maximum static friction coefficient of friction between an inner surface of the wear-resistant layer at the tire inner side and the inner surface of the wear-resistant layer is greater than or equal to a maximum static friction coefficient of friction between an inner surface of the wear-resistant layer at the tire outer side and the inner surface of the wear-resistant layer.

Alternatively, the wear-resistant layer is a wear-resistant lubrication layer having a lubrication function.

Alternatively, the tire inner surface rubber layer at which the wear-resistant layer is disposed is more wear-resistant than the tire inner surface rubber layer.

Alternatively, one of a liquid lubricant, a semisolid lubricant coating layer, and a dry-surface lubrication layer is disposed on inner surfaces of the wear-resistant fabric layer, the wear-resistant paper layer, and the wear-resistant leather layer; and a semisolid lubricant coating layer or a dry-surface lubrication layer is disposed on an inner surface of the wear-resistant film layer.

Alternatively, the wear-resistant coating layer is a dry-surface lubrication coating layer or a semisolid lubricant coating layer having a lubrication property.

Alternatively, thicknesses of the dry-surface lubrication coating layer and the semisolid lubricant coating layer are less than 1.5 mm.

According to the experiment of the inventor, the test air temperature is 10° C., the road is flat, and a tire model is 215/50/R17. An existing tire without inner tube and unsupported by sidewall is used. After a tire of a turning wheel has zero pressure, a vehicle continues to move at 50 kilometers per hour along a straight line, the vehicle deviates, and there is relatively large noise. When the vehicle has moved for less than 5 kilometers, a zero-pressure wheel clearly jumps up and down, a steering wheel shakes, and the vehicle jolts. The surface of a tire shoulder near a tire sidewall becomes uneven. After the tire is removed, there is a large number of shattered pieces of rubber inside the tire, and the wear is severe.

According to the experiment of the inventor, the test air temperature is 10° C., the road is flat, and a tire model is 215/50/R17. After a wear-resistant lubrication layer is disposed at three portions, that is, a tire bead, a tire sidewall, and a tire shoulder, on a tire outer side and a tire inner side of a tire without inner tube and unsupported by sidewall and after a tire of a turning wheel has zero pressure, a vehicle continues to move at 50 kilometers per hour along a straight line. The vehicle deviates to a less extent, movement noise is reduced. After the vehicle has moved 20 kilometers, a zero-pressure wheel moves smoothly, and the vehicle does not clearly jump up and down. The surface of the tire shoulder near the tire sidewall does not become uneven, and the vehicle moves smoothly. After the tire is removed, there are no clear shattered pieces of rubber inside the tire, and the wear is slight. At 50 kilometers per hour, the vehicle can continuously move more than 40 kilometers.

The present disclosure has the following functions: Under the premise of ensuring that the tire is comfortable to use, assembly and disassembly are convenient, and dynamic balance of the wheel is not affected, after the tire has zero pressure and goes flat: 1. The wear-resistant lubrication layer can reduce a friction coefficient at a contact position on a tire inner surface at the tire outer side, lateral friction decreases, and a decrease in the lateral friction can avoid or reduce a risk of tire bead unseating at the tire outer side. 2. The wear-resistant lubrication layer can reduce a friction coefficient at a contact position on the tire inner surface, and the decrease in friction can reduce rolling resistance of the tire, to prevent an unbalanced exertion of force at two sides of the wheel, thereby improving the controllability of a vehicle. 3. A wear-resistant layer can improve wear resistance performance at the contact position on the tire inner surface, thereby increasing a movement distance and speed limitations. 4. At a particular vehicle speed, the wear-resistant lubrication layer can prevent the zero-pressure wheel from jumping up and down, to avoid jolting of the vehicle.

Another function of the present disclosure is that during a movement of the vehicle, when a tire with a normal tire pressure hits a pit or bump and is subject to severe impact, two inner surfaces of the tire bead, a tire sidewall, and the tire shoulder of the tire are attached, and the wear-resistant lubrication layer can reduce the impact on the tire bead, the tire sidewall, and the tire shoulder of the tire, to reduce a probability that tire fabrics inside the tire shoulder, the tire sidewall, and the tire bead of the tire are subject to impact and damage to swell.

The tire of the present disclosure is also applicable to a plane.

The present disclosure has the following beneficial effects: The pneumatic tire without inner tube and unsupported by sidewall has a very soft tire sidewall and is prone to bending and deformation. Bending and deformation resistance of the tire sidewall after the wear-resistant layer is disposed at an inner surface of the tire sidewall is one to two times the bending and deformation resistance of the tire sidewall before the wear-resistant layer is disposed. The tire sidewall is still prone to deformation, so as to keep the comfort of the tire.

The wear-resistant fabric layer, the wear-resistant paper layer, the wear-resistant film layer, and the wear-resistant leather layer have soft materials and have particular elasticity and extensibility. After a rubber coating layer or a bonding agent are sprayed or printed on singles surfaces of these layers, these layers are attached at the tire inner surface rubber layer before vulcanization. Primary vulcanization is then performed. In this way, these layers can be securely attached on an inner sidewall in the tire.

The wear-resistant fabric layer, the wear-resistant paper layer, the wear-resistant film layer, and the wear-resistant leather layer may be manufactured with very small thicknesses. Therefore, the thickness of the wear-resistant layer may be controlled within a range of 1 mm or 2 mm, and the weight of the tire is slightly increased. Under a particular condition, the increase in the weight of the tire may be controlled to be within 500 g.

At the tire inner side, coating layers for increasing friction are disposed on the inner surfaces of the wear-resistant fabric layer, the wear-resistant paper layer, the wear-resistant film layer, and the wear-resistant leather layer of the tire. The wear-resistant coating layer is a wear-resistant friction increasing coating layer having a friction increasing function. After the tire has zero pressure and goes flat, a contact position on the tire inner surface at the tire inner side can be better prevented from sliding with respect to each other, thereby reducing the risk of tire bead unseating at the tire outer side.

The wear-resistant fabric layer, the wear-resistant paper layer, and the wear-resistant leather layer are adsorptive and can adequately adsorb a liquid lubricant and a semisolid lubricant coating layer. When the tire rotates and vibrates at a high speed, the lubricant can be prevented from being thrown off. When the tire goes flat, the lubricant can be prevented from being pressed off, thereby ensuring an adequate lubricating property. The dry-surface lubrication layer on the fabric layer can be obtained by performing lubrication treatment on the surface of threads.

A minimum annular radius formed by a liquid lubricant and a semisolid lubricant is greater than an inner radius of the tire by more than 5 mm. An objective is to prevent the liquid lubricant and the semisolid lubricant from being applied to a place at which the tire bead fits a hub during assembly and disassembly of the tire, to avoid reducing the resistance of tire bead unseating.

When a liquid material and a semisolid material are applied to the surface of the fabric layer, the paper layer, the film layer, and the leather layer, static electricity from friction can be prevented.

The tire outer side is a side that is the most easily visible to a person from an outer side after the tire is mounted on the vehicle, and the tire inner side is a side that is not easily visible to a person from the outer side after the tire is mounted on the vehicle.

### BRIEF DESCRIPTION OF THE DRAWINGS

FIG. 1 is a schematic sectional view of a tire;

FIG. 2 is a schematic sectional view of a hub and a tire in an inflated state;

FIG. 3 is another schematic sectional view of a cross-section of a tire;

FIG. 4 is a schematic diagram of a hub;

FIG. 5 is a schematic sectional view of a hub and a tire in a zero-pressure state;

FIG. 6 is a force diagram of a hub and a tire in a zero-pressure state;

FIG. 7 is a schematic diagram of a wear-resistant layer being disposed on a tire inner surface rubber layer in a pneumatic tire without inner tube and unsupported by sidewall according to the present disclosure; and

FIG. 8 is a schematic diagram of the definition of a camber angle of a right-side wheel.

### REFERENCE NUMERALS

10—horizontal ground, 20—tire outer side, and 21—tire inner side; 30—hub, and 31—inner rim; 32—tire bead seat at an inner side of a vehicle body; 33—groove of the hub; 34—tire bead seat at an outer side of the vehicle body; 35—outer rim; 36—rim inner surface; 37—height of the outer rim from the horizontal ground; 38—height of the inner rim from the horizontal ground; and 100—tire bead, 110—inner surface of the tire bead, 120—inner surface of the tire bead at the tire outer side, 123—wear-resistant layer on the inner surface of the tire bead at the tire outer side, 130—inner surface of the tire bead at the tire inner side, 133—wear-resistant layer on the inner surface of the tire bead at the tire inner side, 140—bead apex of a tire, 150—tire lip, 200—tire sidewall, 210—inner surface of the tire sidewall, 220—inner surface of the tire sidewall at the tire outer side, 221—tire bending position at the tire outer side, 222—tire groove structure at the tire outer side, 223—wear-resistant layer on the inner surface of the tire sidewall at the tire outer side, 230—inner surface of the tire sidewall at the tire inner side, 231—tire bending position at the tire inner side, 232—tire groove structure at the tire inner side, 233—wear-resistant layer on the inner surface of the tire sidewall at the tire inner side, 300—tire shoulder, 310—inner side face of the tire shoulder, 320—inner surface of the tire shoulder at the tire outer side, 323—wear-resistant layer on the inner surface of the tire shoulder at the tire outer side, 330—inner surface of the tire shoulder at the tire inner side, 333—wear-resistant layer on the inner surface of the tire shoulder at the tire inner side, 400—tire tread, 410—inner surface of the tire tread, 500—tire inner surface, 510—contact position on the tire inner surface at the tire outer side, and 520—contact position on the tire inner surface at the tire inner side.

N1—tire ground support force at the outer rim, N2—tire ground support force at the inner rim, N10—support force at the contact position on the tire inner surface at the tire outer side, N20—support force at the contact position on the tire inner surface at the tire inner side, F1—tire ground lateral friction at the outer rim, F2—tire ground lateral friction at the inner rim; F10—lateral friction at a contact position of the tire bead at the tire outer side, F11—pulling force at the tire bending position at the tire outer side, F20—lateral friction at a contact position of the tire bead at the tire inner side, and F21—pushing force at the tire bending position at the tire inner side.

### DETAILED DESCRIPTION OF THE EXEMPLARY EMBODIMENTS

The technical solutions of the present disclosure are further described below with reference to the embodiments and the accompanying drawings.

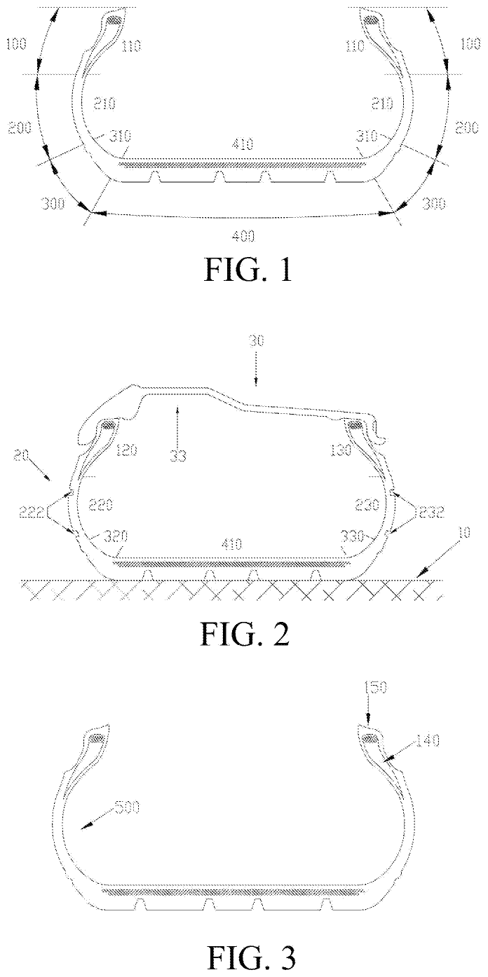

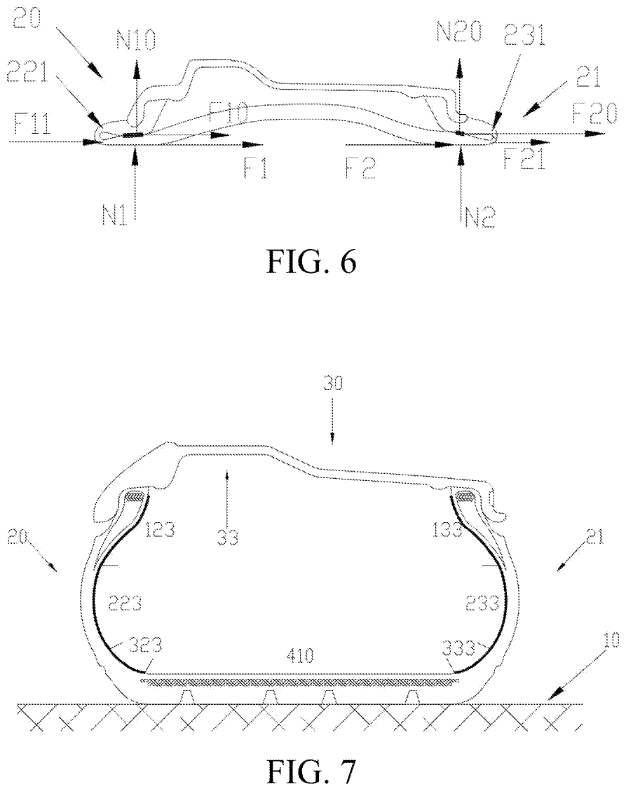

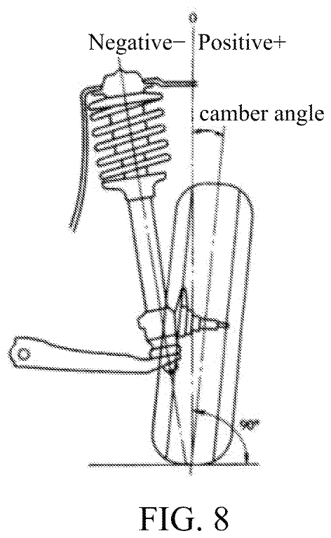

As shown in FIG. 1 to FIG. 3, a tire shown in FIG. 5 and FIG. 6 is a pneumatic tire without inner tube and unsupported by sidewall. Bending and deformation resistance, strength, bearing capability, and external dimensions of tire beads 100 at two sides of the tire are the same or are within ranges of fabrication tolerances. A rubber layer on a tire inner surface 500 is a rubber airtight layer. The material of the tire inner surface 500 is usually chlorobutyl rubber or bromobutyl rubber, and has a very large friction coefficient of mutual friction.

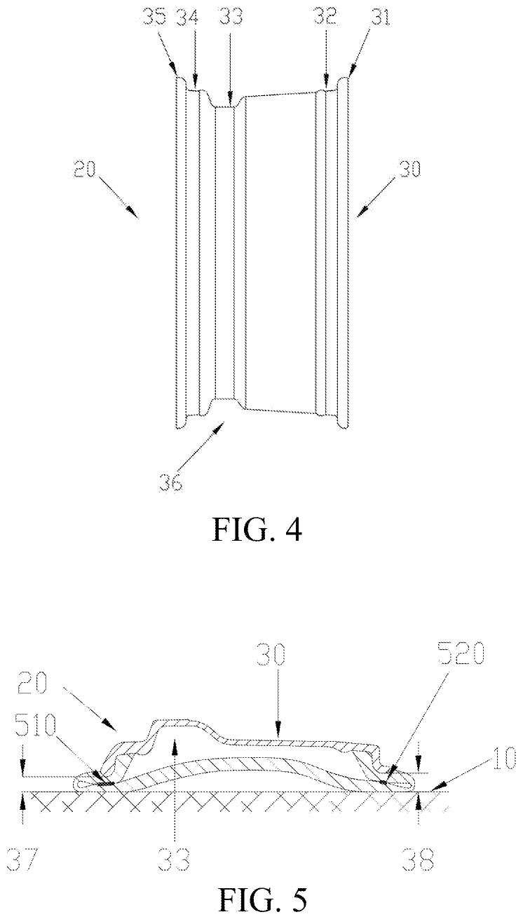

A hub shown in FIG. 2 and FIG. 4 to FIG. 6 is a top-mounted hub with rims at two sides having the same diameter. Diameters of an inner rim 31 and an outer rim 35 are the same or are within ranges allowed by fabrication tolerances.

A bead apex 140 is a main filler of the tire bead 100, produces an effect of supporting a tire wall, and has large bending and deformation resistance and bearing capability. The bead apex 140 has a large thickness at a position close to a tire lip 150 and has large bending and deformation resistance and large bearing capability. The bead apex 140 has a small thickness at a position close to a tire sidewall 200 and has small bending and deformation resistance and small bearing capability. Therefore, the tire bead 100 has large bending and deformation resistance and large bearing capability at the position close to the tire lip 150, and the tire bead 100 has small bending and deformation resistance and small bearing capability at the position close to the tire sidewall 200.

A tire shoulder 300 has a large thickness at a position close to a tire tread 400 and has large bending and deformation resistance and large bearing capability, and the tire shoulder 300 has a small thickness at the position close to the tire sidewall 200 and has small bending and deformation resistance and small bearing capability.

Compared with the tire shoulder 300 and the tire bead 100, the tire sidewall 200 has minimum bending and deformation resistance. Therefore, after the tire has zero pressure and goes flat, a bending area of the tire is located at the tire sidewall 200, and the tire tread 400 may bend and deform. The tire inner surface is in contact, and a contact surface at a contact position on the tire inner surface at a side bearing the largest weight of a rim is an inner surface 110 of the tire bead.

After the tire blows, a tire pressure of the tire is zero. A position that bears a maximum support force in the tire is chosen. Because the tire is in a rolling state, a support force at the position from the horizontal ground 10 is an impulsive force. The support force changes from 0 to the maximum and then changes from the maximum to zero. A cycle is completed every time the position makes one revolution. If the zero-pressure tire is subject to a lateral force, the lateral force at the position also changes from 0 to the maximum, and then changes from the maximum to zero. A cycle is completed every time the position makes one revolution.

When the tire of the left front wheel blows during a clockwise movement along a curve, after the tire goes flat, the unseating problem of the tire lip at a tire outer side is correlated to a curve radius, a speed, and the mass of a vehicle. A lateral force on the overall vehicle=the mass of the vehicle×the square of the speed/the curve radius. For the same vehicle, when the lateral force on the overall vehicle on a horizontal road surface is larger, a probability of tire bead unseating is larger. Under the same condition, when a height of a cross-section of the tire is larger at a standard pressure is larger, a vehicle body has a larger tilt, the lateral force is larger, and a probability of tire bead unseating is larger.

The fabric layer in the present disclosure includes a knit fabric layer, a woven fabric layer, a non-woven fabric layer, and a third fabric layer. A fabric is a flat soft sheet formed by interweaving, winding, and connecting small soft long materials. A woven fabric is formed by yarns having an interwoven relationship. A knit fabric is formed by yarns having a wound relationship. A non-woven fabric is formed by yarns having a connection relationship. A third fabric is formed by yarns having an interwoven/wound relationship. The fabric is formed after numerous yarns have a stable relationship. Felt is a fabric.

The fabric layer in the present disclosure may be a nylon fabric, a non-woven fabric, a flax fabric, an ultra-high-molecular-weight polyethylene fabric, a polytetrafluoroethylene fabric, a capron fabric, a polyamide fabric, a graphite fabric, a carbon fiber fabric, a nylon fabric, and a tetrafluoroethylene fabric having an excellent lubrication property.

A film layer in the present disclosure is soft, bendable, and deformable, and may be a nylon film or a plastic film.

The film layer in the present disclosure may be alternatively a polytetrafluoroethylene film, an ultra-high-molecular-weight polyethylene film, a molybdenum disulfide film, or a polyester film. These films have a lubricating property.

A wear-resistant coating layer is disposed on the tire of the present disclosure inner surface. The dry-surface lubrication coating layer is a dry-surface metal coating layer, a dry-surface coating layer containing a tetrafluoroethylene material, or a dry-surface coating layer containing a molybdenum disulfide material. These coating layers all have a lubricating property. A semisolid lubricant is a polyether lubricating grease, or a silicone lubricating grease. The semisolid lubricant is a molybdenum disulfide lubricating grease or a fluoroether-based lubricating grease.

The wear-resistant layer in the present disclosure may be alternatively a wear-resistant rubber layer, a wear-resistant polyurethane layer or another high-molecular wear-resistant material layer. They may be used in place of the foregoing wear-resistant film layer. A rubber material of the wear-resistant rubber layer may be butyronitrile rubber with excellent wear resistance performance.

The wear-resistant layer in the present disclosure and a bump structure may be alternatively disposed on an inner surface of the tire tread.

A normal tire is used as an example.

Referring to FIG. 3 to FIG. 6, the position that bears the maximum support force in the tire is chosen. The tire in FIG. 5 and FIG. 6 is the left front tire. At a normal tire pressure, a camber angle of a wheel is zero. During a linear movement, after the left front tire blows and goes flat, the vehicle body tilts, and the camber angle of the flat-tire wheel become positive. During the linear movement of the vehicle, when the tire of the left front wheel blows, the vehicle body tilts, an inner surface of the vehicle is in contact. The flat tire is subject to a lateral force from an outer side of the vehicle body to an inner side of the vehicle body. During the clockwise movement along the curve, after the tire of the left front wheel blows and the tire goes flat, the vehicle body tilts, the camber angle of the flat-tire wheel becomes positive, and the flat tire is subject to the lateral force from the outer side of the vehicle body to the inner side of the vehicle body. For the same vehicle at the same vehicle speed, a tilt angle of the vehicle body when the tire of the left front wheel blows during the clockwise movement along the curve is greater than a tilt angle of the vehicle body when the tire of the left front wheel blows during the linear movement.

When the camber angle of the flat-tire wheel becomes positive, a height 37 of the outer rim from the horizontal ground is less than a height 38 of the inner rim from the horizontal ground. Therefore, a tire ground support force N1 at the outer rim is greater than a tire ground support force N2 at the inner rim. A support force N10 at a contact position on the tire inner surface at the tire outer side is greater than a support force N20 at a contact position on the tire inner surface at a tire inner side.

During the clockwise movement along the curve, the tire of the left front wheel blows. A height difference between the height 37 of the outer rim from the horizontal ground and the height 38 of the inner rim from the horizontal ground is greater than a height difference therebetween when the tire of the left front wheel blows during the linear movement at the same vehicle speed. Because the rubber layer on the tire inner surface 500 is a rubber airtight layer. The material of the rubber airtight layer is chlorobutyl rubber or bromobutyl rubber, and has a very large friction coefficient of mutual friction. Therefore, lateral friction F10 at a contact position of the tire bead at the tire outer side is far greater than a pulling force F11 at a tire bending position at the tire outer side. Tire bead unseating at the tire outer side is mainly caused by the lateral friction F10 at the contact position of the tire bead at the tire outer side.

A contact surface at a contact position 510 on the tire inner surface at the tire outer side is an inner surface 120 of the tire bead at the tire outer side. The contact position 510 on the tire inner surface at the tire outer side is close to the tire lip 150. Because the bead apex 140 of the tire at an outer side at this position has a large thickness and has large bending and deformation resistance and large bearing capability, the lateral friction F10 at the contact position of the tire bead at the tire outer side is rapidly transferred to the tire bead, and a loss is small. When the zero-pressure tire is subject to the relatively large lateral force from the outer side of the vehicle body to the inner side of the vehicle body, the tire lip 150 at the outer side of the vehicle body is unseated from a tire bead seat 34 at the outer side of the vehicle body and slides into a groove 33 of the hub, and braking and steering are out of control to cause a traffic accident.

### Embodiment 1

Refer to FIG. 1 to FIG. 3 and FIG. 5 to FIG. 7. In FIG. 5 to FIG. 7, the tire is the left front tire, and the vehicle is a family car. At a normal tire pressure, the camber angle of the wheel is zero. The tire is a tire with a small aspect ratio. A height of the tire sidewall 200 of the tire is small. A wear-resistant layer 123 on an inner surface of the tire bead at the tire outer side and a wear-resistant layer 133 on an inner surface of the tire bead at the tire inner side are disposed on the inner surface 110 of the tire bead at two sides of the tire.

Alternatively, when the wear-resistant layer 123 on the inner surface of the tire bead at the tire outer side and the wear-resistant layer 133 on the inner surface of the tire bead at the tire inner side are disposed on the inner surface 110 of the tire bead at two sides, a wear-resistant layer 223 on an inner surface of the tire sidewall at the tire outer side and a wear-resistant layer 233 on the inner surface of the tire sidewall at the tire inner side are disposed on an inner surface 210 of the tire sidewall, and a wear-resistant layer 323 on the inner surface of the tire shoulder at the tire outer side and a wear-resistant layer 333 on the inner surface of the tire shoulder at the tire inner side are disposed on an inner side face 310 of the tire shoulder.

The wear-resistant layer is a wear-resistant lubrication layer, including a silicone lubricating grease, a nylon fabric, and a rubber layer. A thickness of the wear-resistant lubrication layer is 1 mm. A rubber layer of a rubber nylon fabric is first attached to an inner surface of the tire inner surface 500, and vulcanization molding is subsequently performed. The silicone lubricating grease and the nylon fabric have an excellent lubricating property and wear resistance.

The tire has a normal tire pressure. When the vehicle hits a pit and a curb, the tire is subject to impact. The inner surface 110 of the tire bead of the tire is an impacted surface. The silicone lubricating grease has an adequate lubricating property and is extremely smooth, so that a probability that tire fabrics inside the tire bead 100, the tire sidewall 200, and the tire shoulder 300 are subject to impact and damage to swell can be reduced.

During the clockwise movement along the curve, the tire of the left front wheel blows and goes flat, the vehicle body tilts, the flat tire is subject to the lateral force from the outer side of the vehicle body to the inner side of the vehicle body, the camber angle of the flat-tire wheel becomes positive, and the position that bears the maximum support force in the tire is chosen. The height 37 of the outer rim from the horizontal ground is less than the height 38 of the inner rim from the horizontal ground. The tire ground support force N1 at the outer rim is greater than the tire ground support force N2 at the inner rim. The support force N10 at the contact position on the tire inner surface at the tire outer side is greater than a support force N20 at the contact position on the tire inner surface at the tire inner side. The lateral friction F10 at the contact position of the tire bead at the tire outer side is greater than lateral friction F20 at a contact position of the tire bead at the tire inner side. Because the tire has a small aspect ratio, the height of the cross-section of the tire is small, the vehicle body tilts slightly, a difference between the tire ground support force N1 at the outer rim and the tire ground support force N2 at the inner rim is small, and a difference between the support force N10 at the contact position on the tire inner surface at the tire outer side and the support force N20 at the contact position on the tire inner surface at the tire inner side is small. A difference between the lateral friction F10 at the contact position of the tire bead at the tire outer side and the lateral friction F20 at the contact position of the tire bead at the tire inner side is small.

Contact surfaces at the contact position 510 on the tire inner surface at the tire outer side and a contact position 520 on the tire inner surface at the tire inner side are the inner surface 110 of the tire bead. The inner surface 110 of the tire bead has a semisolid silicone lubricating grease, a friction coefficient is small. Both the lateral friction F10 at the contact position of the tire bead at the tire outer side and the lateral friction F20 at the contact position of the tire bead at the tire inner side are relatively small. At the contact position 510 on the tire inner surface at the tire outer side and the contact position 520 on the tire inner surface at the tire inner side, the tire tread 400 slides relative to a hub 30. The pulling force F11 at the tire bending position at the tire outer side and a pushing force F21 at a tire bending position at the tire inner side are relatively large.

The pulling force F11 at the tire bending position at the tire outer side is applied to a position, close to the tire sidewall 200, of the tire bead 100 at the outer side of the vehicle body through a tire bending position 221 at the tire outer side, the tire bead 100 deforms. In addition, the tire bending position 221 at the tire outer side is subject to a force to bend and deform. A force eventually applied to the tire bead at the outer side of the vehicle body from the pulling force F11 at the tire bending position at the tire outer side is delayed and weakened.

Because the flat tire is in a rolling state, a lateral force applied to the flat tire changes from 0 to the maximum and then changes from the maximum to zero. A cycle is completed every time the tire makes one revolution. The lateral force applied to the flat tire is an intermittent impulsive force. Because the tire is a tire with a small aspect ratio, the height of the tire sidewall 200 of the tire is small. The tire bending position 221 at the tire outer side and a tire bending position 231 at the tire inner side have small bending portions, and a sliding amount of the tire tread 400 relative to the hub 30 is small, the controllability of the vehicle is slightly affected.

With such an arrangement: 1. A probability that the tire lip 150 at the outer side of the vehicle body is unseated from the tire bead seat 34 at the outer side of the vehicle body and slides into the groove 33 of the hub is reduced, so that tire bead unseating is reduced and the occurrence of traffic accidents is reduced. 2. Because a friction coefficient between the contact position 520 on the tire inner surface at the tire inner side and the contact position 510 on the tire inner surface at the tire outer side is less than a friction coefficient of a normal tire, rolling resistance of the flat tire is less than that of the normal tire, to prevent an unbalanced exertion of force at two sides of the wheel, thereby improving the controllability of the vehicle. After the tire blows, compared with the normal tire, the vehicle can move a longer distance.

The aspect ratio of the tire is a ratio of a height and a width of the cross-section of the tire at a standard pressure.

An objective of this embodiment is to ensure that when the vehicle moves along a circle with a radius of 25 meters at 40 kilometers per hour, unseating does not occur in the tire at zero pressure at an outer side of the circle during a movement.

A wear-resistant layer is not disposed on an inner surface of the tire tread for the following reasons: 1. making it convenient to repairing the tire; and 2. considering airtightness because there is no airtightness requirement for a wear-resistant layer; and reducing the weight of the tire and reducing a production cost.

### Embodiment 2

Refer to FIG. 1 to FIG. 3 and FIG. 5 to FIG. 7. The tire in FIG. 5 to FIG. 7 is the left front tire. Compared with Embodiment 1, only the tire is different in this embodiment. Differences lie in that: 1. The height of the tire sidewall 200 is different from that in Embodiment 1. The height of the tire sidewall 200 is slightly greater than the height of the tire sidewall 200 in Embodiment 1, and the height of the cross-section of the tire at a standard pressure is greater than that in Embodiment 1. 2. The wear-resistant layer 123 on the inner surface of the tire bead at the tire outer side, the wear-resistant layer 223 on the inner surface of the tire sidewall at the tire outer side, and the wear-resistant layer 323 on the inner surface of the tire shoulder at the tire outer side is a wear-resistant lubrication layer, including a silicone lubricating grease, a nylon fabric, and a rubber layer. The thickness of the wear-resistant lubrication layer is 1 mm. A rubber layer of a rubber nylon fabric is first attached on the inner surface of the tire inner surface 500, and subsequently vulcanization molding is performed. The silicone lubricating grease and the nylon fabric have an excellent lubricating property and wear resistance. The wear-resistant layer 133 on the inner surface of the tire bead at the tire inner side, the wear-resistant layer 233 on the inner surface of the tire sidewall at the tire inner side, and the wear-resistant layer 333 on the inner surface of the tire shoulder at the tire inner side are wear-resistant layers, including the nylon fabric and a rubber layer, a thickness of which is 1 mm.

The silicone lubricating grease and the nylon fabric have an excellent lubricating property and wear resistance, and a friction coefficient is the same as that in Embodiment 1. The nylon fabric has excellent wear resistance, and a friction coefficient of the nylon fabric is greater than a friction coefficient of the silicone lubricating grease and the nylon fabric.

The tire has a normal tire pressure. When the vehicle hits a pit and a curb and the inner surface 120 of the tire bead at the tire outer side is subject to impact, the silicone lubricating grease has an adequate lubricating property and is extremely smooth, so that a probability that tire fabrics are subject to impact and damage to swell can be reduced. When the inner surface 130 of the tire bead at the tire inner side is subject to impact, because a friction coefficient of the nylon fabric is less than a friction coefficient of the inner surface of the tire inner surface 500, a probability that tire fabrics are subject to impact and damage to swell can be reduced.

The same curve and vehicle speed in Embodiment 1 are used to make the clockwise movement in this embodiment. The tire of the left front wheel blows and goes flat, the vehicle body tilts, and the flat tire is subject to the lateral force from the outer side of the vehicle body to the inner side of the vehicle body. The camber angle of the flat-tire wheel becomes positive. The position that bears the maximum support force in the tire is chosen. The height 37 of the outer rim from the horizontal ground is less than the height 38 of the inner rim from the horizontal ground. Because the height of the tire sidewall 200 is greater than the height of the tire sidewall 200 in Embodiment 1, the height difference between the height 37 and the height 38 is greater than that in Embodiment 1. The tire ground support force N1 at the outer rim is greater than the tire ground support force N2 at the inner rim. The tire ground support force N1 at the outer rim is greater than the tire ground support force N1 at the outer rim in Embodiment 1. The tire ground support force N2 at the inner rim is less than the tire ground support force N2 at the inner rim in Embodiment 1. The support force N10 at the contact position on the tire inner surface at the tire outer side is greater than the support force N20 at the contact position on the tire inner surface at the tire inner side. The support force N10 at the contact position on the tire inner surface at the tire outer side is greater than the support force N10 at the contact position on the tire inner surface at the tire outer side in Embodiment 1. The support force N20 at the contact position on the tire inner surface at the tire inner side is less than the support force N20 at the contact position on the tire inner surface at the tire inner side in Embodiment 1.

A nylon fabric is provided on a contact surface at the contact position 520 on the tire inner surface at the tire inner side, and has a relatively large friction coefficient. At the position, the tire tread 400 is kept still relative to the hub 30 and the horizontal ground 10, and the friction is large. The contact position 510 on the tire inner surface at the tire outer side is the inner surface 120 of the tire bead at the tire outer side. The inner surface 120 of the tire bead at the tire outer side is a semisolid silicone lubricating grease, a friction coefficient is small, and friction is small. The lateral friction F20 at the contact position of the tire bead at the tire inner side is greater than F20 in Embodiment 1. A sum of the lateral friction F20 at the contact position of the tire bead at the tire inner side and the pushing force F21 at the tire bending position at the tire inner side is greater than a sum of the lateral friction F20 at the contact position of the tire bead at the tire inner side in Embodiment 1 and the pushing force F21 at the tire bending position at the tire inner side. A force applied to the tire bead at the tire outer side decreases. A probability that the tire lip 150 at the outer side of the vehicle body is unseated from the tire bead seat 34 at the outer side of the vehicle body and slides into the groove 33 of the hub is less than that in Embodiment 1, so that traffic accidents can be reduced.

### Embodiment 3

Refer to FIG. 1 to FIG. 3 and FIG. 5 to FIG. 7. The tire in FIG. 5 to FIG. 7 is the left front tire. Compared with Embodiment 2, only the tire is different in this embodiment. Differences lie in that: 1. The height of the tire sidewall 200 is greater than the height of the tire sidewall 200 in Embodiment 2, and the height of the cross-section of the tire at a standard pressure is greater than that in Embodiment 2. 2. The wear-resistant layer 123 on the inner surface of the tire bead at the tire outer side, the wear-resistant layer 223 on the inner surface of the tire sidewall at the tire outer side, and the wear-resistant layer 323 on the inner surface of the tire shoulder at the tire outer side is a wear-resistant lubrication layer, including a silicone lubricating grease, a nylon fabric, and a rubber layer. The thickness of the wear-resistant lubrication layer is 1 mm. The inner surface 130 of the tire bead at the tire inner side, an inner surface 230 of the tire sidewall at the tire inner side, and an inner surface 330 of the tire shoulder at the tire inner side is not disposed as an inner surface of an airtight layer.

During the linear movement of the vehicle, after the left front tire blows and goes flat, the vehicle body tilts, and the camber angle of the flat-tire wheel becomes positive. When the tire of the left front wheel blows during the linear movement, the vehicle body tilts, the flat tire is subject to the lateral force from the outer side of the vehicle body to the inner side of the vehicle body, and the lateral force is relatively small. Because the contact position 510 on the tire inner surface at the tire outer side is the inner surface 120 of the tire bead at the tire outer side, the inner surface 120 of the tire bead at the tire outer side is a semisolid silicone lubricating grease, a friction coefficient is small, and friction is small. Therefore, a probability that the tire lip 150 at the outer side of the vehicle body is unseated from the tire bead seat 34 at the outer side of the vehicle body and slides into the groove 33 of the hub is very small.

The tilt angle of the vehicle body when the tire of the left front wheel blows during the clockwise movement along the curve of the same vehicle at the same vehicle speed is greater than the tilt angle of the vehicle body when the tire of the left front wheel blows during the linear movement.

The same curve and the same vehicle speed in Embodiment 2 are used to make the clockwise movement in this embodiment. The tire of the left front wheel blows and goes flat, and the vehicle body tilts. Because the height of the tire sidewall 200 is relatively large, the tilt is relatively large, and a probability that the tire lip on the tire outer side is unseated is greater than that in Embodiment 2.

The vehicle makes the clockwise movement along a circle with a radius of 25 meters with the left front wheel having a zero pressure. The support force N10 at the contact position on the tire inner surface at the tire outer side is very large. The support force N20 at the contact position on the tire inner surface at the tire inner side is very small or is zero. The lateral force is nearly completely counteracted by the lateral friction F10 at the contact position of the tire bead at the tire outer side and the pulling force F11 at the tire bending position at the tire outer side. The tire lip on the tire outer side is highly prone to unseating. In this case, another solution needs to be adopted to reduce the support force N10 at the contact position on the tire inner surface at the tire outer side, so that the support force N20 at the contact position on the tire inner surface at the tire inner side is increased to resolve the unseating problem.

### Embodiment 4

As shown in FIG. 2, at the tire outer side and/or the tire inner side, at least two groove structures for avoiding stress concentration are disposed on an outer surface of the tire sidewall. One of the two groove structures is disposed at a position close to the tire shoulder, and the other is disposed at a position close to the tire bead. Reference may be made to a tire groove structure 222 at the tire outer side and a tire groove structure 232 at the tire inner side.

After the tire has zero pressure and goes flat, a groove structure for avoiding stress concentration is disposed on the outer surface of the tire sidewall, so that stress concentration at a bending position after the tire goes flat can be prevented, thereby improving the bending life.

### Embodiment 5

In this embodiment, in the wear-resistant lubrication layer in Embodiment 1 to Embodiment 3, a silicone lubricating grease, a nylon fabric, and a rubber layer are replaced with a semisolid lubricating grease. The semisolid lubricating grease is bonded to the tire inner surface 500. A thickness of the semisolid lubricating grease does not exceed 0.2 mm. The semisolid lubricating grease and the tire inner surface 500 have excellent affinity, so that the semisolid lubricating grease can be prevented from being thrown off by a rotating wheel.

The foregoing sequence of the embodiments are merely for the convenience of description, and do not imply the preference among the embodiments.

Finally, it should be noted that the foregoing embodiments are merely intended for describing the technical solutions of the present disclosure rather than limiting the present disclosure. Although the present disclosure is described in detail with reference to the foregoing embodiments, persons of ordinary skill in the art should understand that they may still make modifications to the technical solutions described in the foregoing embodiments or make equivalent replacements to some the technical features thereof, without departing from the scope of the technical solutions of the embodiments of the present disclosure.

What is claimed is:

1. A pneumatic tire without inner tube and unsupported by sidewall, wherein a wear-resistant layer is disposed at a tire inner surface rubber layer of a tire outer side, or disposed at a tire inner surface rubber layer of the tire outer side and a tire inner side, and the wear-resistant layer is located at at least one of the following three portions: a tire bead, a tire sidewall, and a tire shoulder.

2. The pneumatic tire without inner tube and unsupported by sidewall according to claim 1, wherein the wear-resistant layer at the tire inner surface rubber layer is at least one of a wear-resistant fabric layer, a wear-resistant paper layer, a wear-resistant film layer, a wear-resistant leather layer, and a wear-resistant coating layer.

3. The pneumatic tire without inner tube and unsupported by sidewall according to claim 1, wherein the tire inner surface rubber layer is an airtight layer, and the wear-resistant layer is a wear-resistant rubber layer having wear resistance greater than that of the airtight layer.

4. The pneumatic tire without inner tube and unsupported by sidewall according to claim 2, wherein a thickness of the wear-resistant layer is less than 2 mm.

5. The pneumatic tire without inner tube and unsupported by sidewall according to claim 3, wherein a thickness of the wear-resistant layer is less than 2 mm.

6. The pneumatic tire without inner tube and unsupported by sidewall according to claim 2, wherein bending and deformation resistance of the tire sidewall after the wear-resistant layer is disposed at an inner surface rubber layer of the tire sidewall is one to two times the bending and deformation resistance of the tire sidewall before the wear-resistant layer is disposed.

7. The pneumatic tire without inner tube and unsupported by sidewall according to claim 3, wherein bending and deformation resistance of the tire sidewall after the wear-resistant layer is disposed at an inner surface rubber layer of the tire sidewall is one to two times the bending and deformation resistance of the tire sidewall before the wear-resistant layer is disposed.

8. The pneumatic tire without inner tube and unsupported by sidewall according to claim 2, wherein in a case that an inner surface of the wear-resistant layer has the same roughness, a maximum static friction coefficient of friction between an inner surface of the wear-resistant layer at the tire inner side and the inner surface of the wear-resistant layer is greater than or equal to a maximum static friction coefficient of friction between an inner surface of the wear-resistant layer at the tire outer side and the inner surface of the wear-resistant layer.

9. The pneumatic tire without inner tube and unsupported by sidewall according to claim 3, wherein in a case that an inner surface of the wear-resistant layer has the same roughness, a maximum static friction coefficient of friction between an inner surface of the wear-resistant layer at the tire inner side and the inner surface of the wear-resistant layer is greater than or equal to a maximum static friction coefficient of friction between an inner surface of the wear-resistant layer at the tire outer side and the inner surface of the wear-resistant layer.

10. The pneumatic tire without inner tube and unsupported by sidewall according to claim 2, wherein the wear-resistant layer is a wear-resistant lubrication layer having a lubrication function.

11. The pneumatic tire without inner tube and unsupported by sidewall according to claim 3, wherein the wear-resistant layer is a wear-resistant lubrication layer having a lubrication function.

12. The pneumatic tire without inner tube and unsupported by sidewall according to claim 2, wherein the tire inner surface rubber layer at which the wear-resistant layer is disposed is more wear-resistant than the tire inner surface rubber layer.

13. The pneumatic tire without inner tube and unsupported by sidewall according to claim 2, wherein one of a liquid lubricant, a semisolid lubricant coating layer, and a dry-surface lubrication layer is disposed on inner surfaces of the wear-resistant fabric layer, the wear-resistant paper layer, and the wear-resistant leather layer; and a semisolid lubricant coating layer or a dry-surface lubrication layer is disposed on an inner surface of the wear-resistant film layer.

14. The pneumatic tire without inner tube and unsupported by sidewall according to claim 2, wherein the wear-resistant coating layer is a dry-surface lubrication coating layer or a semisolid lubricant coating layer having a lubrication property.

15. The pneumatic tire without inner tube and unsupported by sidewall according to claim 14, wherein thicknesses of the dry-surface lubrication coating layer and the semisolid lubricant coating layer are less than 1.5 mm.
